(19) United States
(12) Patent Application Publication
(10) Pub. No.: US 2002/0093471 A1
(43) Pub. Date: Jul. 18, 2002

(54) Display device

(76) Inventor: Sander Jurgen Roosendaal, Eindhoven (NL)

Correspondence Address: Corporate Patent Counsel, U.S. Philips Corporation, 580 White Plains Road, Tarrytown, NY, 10591, US

(21) Appl. No.: 09/993,160

(22) Filed: Nov. 14, 2001

(30) Foreign Application Priority Data
Nov. 14, 2000 (EP) 00203992.3

(51) Int. Cl. G09G 3/36

(52) U.S. Cl. 345/87

(57) ABSTRACT

A fast addressing method for bistable chiral nematic LCDs is obtained by using shifted orthogonal signals for the addressing pulses, so that more rows can be addressed during a single row addressing time, without obtaining artefacts.

The invention relates to a display device comprising a first substrate provided with row electrodes and a second substrate provided with column electrodes, in which overlapping parts of row and column electrodes with an interpositioned layer of electro-optical material define pixels, said electro-optical layer comprising a nematic liquid crystal material which is capable of assuming a plurality of states, further comprising drive means for driving the row electrodes with selection signals and for driving the column electrodes with data signals in conformity with an image to be displayed.

A display device based on two (or more) stable states may be used in various applications, for example, if information written once should be retained for a longer period of time (electronic newspaper, telephony, smart cards, electronic price tags, personal digital assistants, billboards, etc.). The electro-optical effect, in accordance with which the electro-optical layer switches, may be a (bistable) nematic liquid crystal effect such as the supertwist effect, but also the chiral nematic effect.

A pixel in such a display device has a plurality of stable states when the chiral nematic effect is used, namely a light-transmissive state which corresponds to the focal-conic state of a layer of liquid crystal material, and a reflective state which corresponds to the planar state of the layer of liquid crystal material. The color (wavelength) of the reflected light is dependent on the pitch of the liquid crystal material, i.e. the distance across which the director makes a twist of 360 degrees. In the light-transmissive states, light of said color is transmitted to a greater or lesser degree, dependent on the texture (ratio between parts of a pixel in the planar and the focal-conic state, respectively). Moreover, such a display device may also have the homeotropic state; at a high voltage, all molecules (directors) direct themselves towards the field. Incident light then passes the liquid crystal material in an unhindered way. If no polarizers are used, the color in the homeotropic state in a reflective display device is determined by the color of the background, for example, an absorbing layer. The display device is usually only brought to this state so as to reach one of the two stable states. Dependent on the frequency and the voltage used for the switching pulses, a pixel changes to the focal-conic or the planar state.

The selection period (address time) for writing the different states is usually fairly long. Without special measures, they are 20 to 30 msec, which is too long for use in, for example, an electronic newspaper.

The article “Dynamic Drive for Bistable Cholesteric Displays; A Rapid Addressing Scheme”, SID 95 Digest, p. 347 describes how selection periods between the different states can be reduced by a special drive mode, using a preparation phase and an evolution phase.

It is, inter alia, an object of the present invention to reduce the selection period. To this end, a display device according to the invention is characterized in that the drive means comprise means for bringing, in the operative state and prior to a selection period, the liquid crystal material in groups of p rows of pixels in a defined state, said drive means sequentially applying mutually orthogonal signals to m groups of p row electrodes (p>1) in the operative state during a selection period and selecting the rows i, i+p, i+2p, . . . i+(m−1)p during a selection period, (i=1, 2, . . . p).

The use of orthogonal signals is known per se for driving (super)twisted nematic display devices so as to inhibit a phenomenon which is known as frame response. In contrast to the conventional single line addressing, a number of rows is selected simultaneously in this case. This requires a special treatment of incoming signals which must be processed mathematically so as to determine the correct signals for the column electrodes. Said phenomenon of frame response occurs when the frame time becomes too long in proportion to the response time of the liquid crystal material. The transmission of a pixel is then no longer determined by the effective value of the voltage across a plurality of consecutive selections but more or less follows the presented voltage pattern. In the case of orthogonal drive, the drive signals are adapted to be such that a pixel is driven several times per frame time. The transmission is then determined by said effective value of the voltage across a plurality of consecutive selections. When chiral nematic liquid crystal material is used notably in the above-mentioned applications (electronic newspaper, telephony, smart cards and electronic price tags), in which the drive voltage is eliminated after the information has been written once, such a problem does not occur when there are no consecutive selections.

The invention is based on the recognition that the selection period should be sufficiently long so that the liquid crystal (the pixel) reacts to the effective voltage value of the presented signals, whereas a plurality of rows (p) can be simultaneously driven with orthogonal signals within the selection period, in which a column signal is the sum of the products of the desired state of the pixels and the corresponding orthogonal signals on the rows. In the simultaneously driven rows, sufficient energy is then presented so as to cause the pixels to switch. Consequently, the display device is thus written by a factor of p faster. The p rows may be spread on the surface of the display device or may drive a group of consecutive rows. In the latter case, interference voltages appear to reduce the contrast (in a reflective application, this becomes manifest, for example, in a darker display of previously addressed pixels than of pixels addressed at a later stage). According to the invention, by distributing the lines driven with orthogonal signals, as it were, uniformly across the display panel, this is largely prevented.

The reflection (transmission) voltage characteristic is, however, also dependent on the history. The state achieved after selection depends in some cases on the initial situation and, for an initial situation in which the pixel is in the focal-conic state at a voltage of 0 volt, may differ from an initial situation in which the pixel is in the planar state at a voltage of 0 volt. This is not a problem in the case of bistable (for example, alphanumerical) displays but causes a problem when there are quick changes of the image in which grey levels are also to be displayed. To provide for this facility, the drive means comprise means for bringing, in the operative state and prior to a selection period, the liquid crystal material in groups of p rows of pixels in a defined state (reset). This is preferably the homeotropic state, but the focal-conic state is alternatively possible, while even a state associated with a given texture (grey value) is feasible.

For example, Walsh functions are chosen for the orthogonal functions, but other functions are alternatively possible such as Haar functions or Slant functions. To prevent a DC voltage from being built up during a long-lasting drive of the same type of information (for example, a name of a document at the top of a page whose contents change, or the word “page” at the bottom of a page of an electronic newspaper), the voltage integral of the selection voltages in a selection period is preferably zero.

These and other aspects of the invention are apparent from and will be elucidated with reference to the embodiments described hereinafter.

In the drawings:

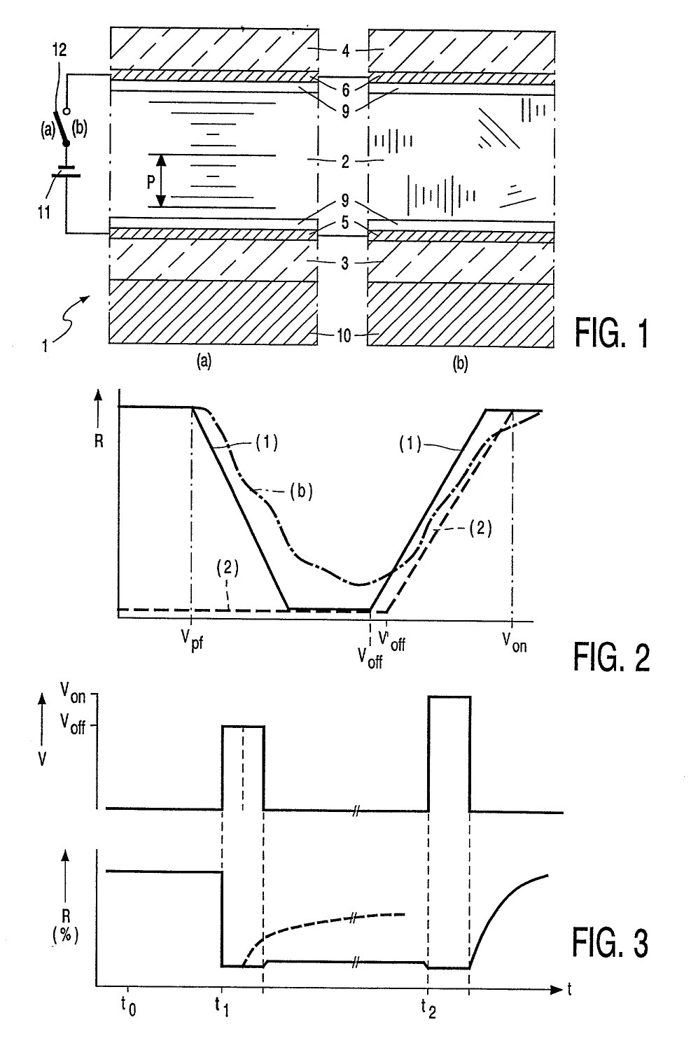

FIG. 1 is a diagrammatic cross-section of a light-modulating cell according to the invention, in two different states,

FIG. 2 shows diagrammatically the voltage-reflection characteristic for the display device of FIG. 1,

FIG. 3 shows the dynamical behavior of a pixel, while

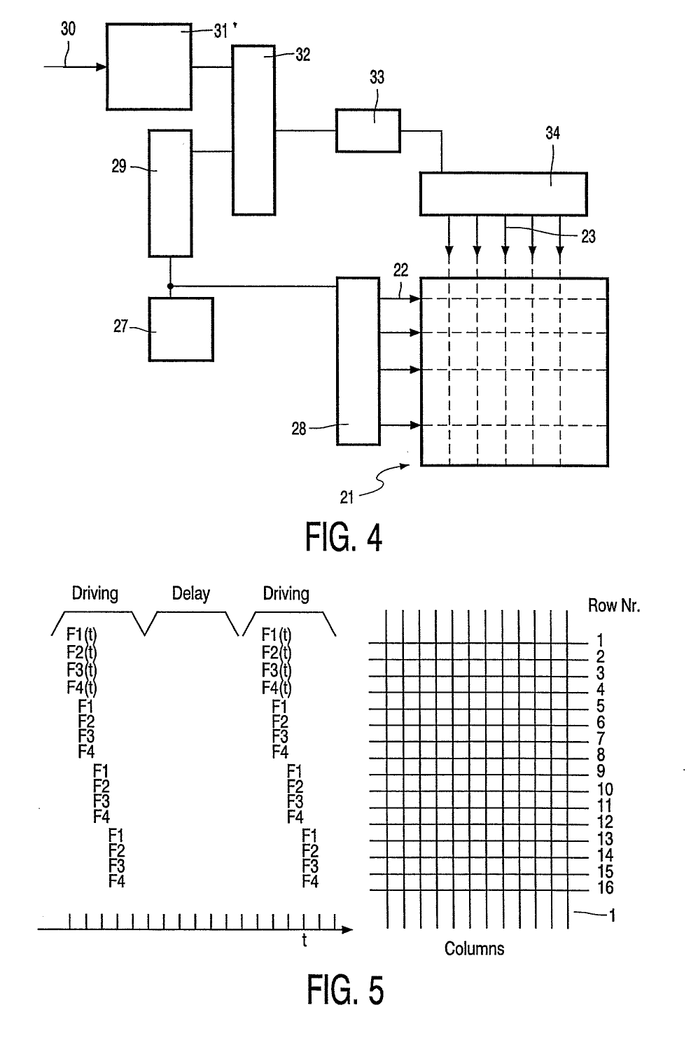

FIG. 4 shows a practical embodiment of a display device with a matrix of a pixel, and

FIGS. 5, 6 and 7 show the variation of the row and column signals for a simplified matrix.

The Figures are not drawn to scale and are diagrammatic.

FIG. 1 is a diagrammatic cross-section of a part of a light-modulating cell 1 with a chiral nematic liquid crystal material 2 which is present between two substrates 3, 4 of, for example, glass, provided with electrodes 5, 6. If necessary, the device comprises orientation layers 9 which orient the liquid crystal material on the inner walls of the substrates. The liquid crystal material has a positive optical anisotropy and a positive dielectric anisotropy in this case. In the embodiment of FIG. 1, the light-modulating cell has an absorbing layer 10.

The chiral nematic liquid crystal material 2 is a mixture of a nematic liquid crystal material with a positive dielectric anisotropy and chiral material which is present in such a quantity that a chiral nematic structure with a given pitch P is obtained; this pitch P is the distance across which the directors of the liquid crystal material undergo a twist of 360 degrees. On a wall of the substrate, the liquid crystal molecules are oriented more or less perpendicularly (or in some cases parallel) to this wall. A first stable state (the planar state) now comprises a helix structure with a pitch P (FIG. 1a). The thickness d of the light-modulating cell is several times the pitch P (for example 6 times, but at least 2 times).

Another stable state which such a chiral nematic liquid crystal material may assume is the focal-conic state (FIG. 1b) which arises after the electrodes 5, 6 are energized with one or more electric voltage pulses of a given value (shown by means of a voltage source 11 and a switch 12 in FIG. 1). As it were, the helix structure is broken up into pieces which are oriented arbitrarily and in which incident light is no longer (partly) reflected but can reach the absorbing background.

The planar state has the property that it reflects light at a wavelength in a band around λ=n.P (n: average refractive index). In the device of FIG. 1, such a liquid has been chosen that the planar structure has such a pitch that it reflects, for example, green light, while a black absorbing background 10 has been chosen. Green characters against a black background (or the other way around) are then generated with the display device shown.

At a high voltage across the light-modulating cell, the liquid crystal material assumes a third state referred to as the homeotropic state, i.e. all molecules direct themselves towards the field and the light-modulating cell is transparent to all (visible) wavelengths. Dependent on the drive voltage and the switching rate, the light-modulating cell switches from this state to the planar or the focal-conic state.

FIG. 2 shows diagrammatically the voltage-reflection characteristic for the pixel of FIG. 1. The state at zero voltage is dependent on the history. By way of illustration, the chiral nematic state is chosen for this purpose, so that the pixel reflects blue light at a high reflection value R. At a pulse with an effective value of the (threshold) voltage V_{pf}, the liquid changes to the focal-conic state (curve 1) in which R is substantially zero (the background is visible). When the effective voltage of the pulse is further increased, the reflection increases from V_{off} to a high value again. If the liquid is in the focal-conic state at 0 volt, the increase of the reflection starts at a slightly higher effective voltage V′_{off} (curve 2) and reaches the high reflection at Vₒₙ. In the transition range V_{off}-Vₒₙ. intermediate reflection levels are possible which are, however, not defined unambiguously; however, this is no drawback for alphanumerical applications. By erasing the display device (or a part thereof), as it were, prior to each selection (writing information), for example (with one or more pulses) via the homeotropic state, it is achieved that the curves (1), (2) coincide so that V_{off} and Vₒₙ are fixed unambiguously. In this case, V_{off} and Vₒₙ are determined by the voltage-reflection characteristic (for example, 1% and 99% of the maximum reflection) but, if necessary, they may be defined differently (for example, 5% and 95% of the maximum reflection). The display device (or a part thereof) may also be erased via the focal-conic state (or another state which has been fixed unambiguously, for example, a grey value such as medium grey).

FIG. 3 shows the dynamic behavior of a pixel being in the planar state at instant t₀, changing to the focal-conic state at instant t₁ and switching again to the homeotropic state at instant t₂ (mainly by the choice of the amplitude of the switching pulses). It relaxes after the pulse(s) to the planar state. It is found that, notably for the transition from the planar state to the focal-conic state, the pulse width of the signal used must have a given minimum value. At a pulse duration which is too short, the pixel relaxes to the planar state again (broken-line curve in FIG. 3). For a satisfactory operation, the duration of the switching signal (preferably presented as an alternating voltage) must be at least 20 msec. For larger picture formats (electronic newspapers) and also for given applications in which fast writing operations must be performed (for example, moving pictures, making electronic labels) this is too long.

According to the invention, p rows are simultaneously driven during a selection period tₛₑ₁ by means of orthogonal selection signals. FIG. 4 shows a practical embodiment of a display device with a matrix 21 of pixels at the area of crossings of N rows 22 and M columns 23. The device further comprises a row function generator 27 formed, for example, as a ROM for generating orthogonal signals Fᵢ(t) for driving the rows 22. During an elementary time interval, row vectors are defined which drive a group of p rows via a drive circuit 28. The row vectors are also written into a row function register 29. For a more extensive description of this drive mode, reference is made to articles by T. J. Scheffer and B. Clifton “Active Addressing Method for High-Contrast Video-Rate STN Displays”, SID Digest 92, pp. 228-231 and by T. N. Ruckmongathan et al. “A New Addressing Technique for Fast Responding STN LCDs”, Japan Display 92, pp. 65-68.

Information 30 to be displayed is stored in an N×M buffer memory 31 and read as information vectors per elementary unit of time. Signals for the columns 23 are obtained by multiplying, during each elementary unit of time, the then valid values of the row vector and the information vector (column vector) and by subsequently adding the p obtained products. The row and column vectors which are valid during an elementary unit of time are multiplied by comparing them in an array 33 of M exclusive ORs. The products are added by supplying the outputs of the array of exclusive ORs to the summing logic 33. The signals from the summing logic 33 control a column drive circuit 34 which provides the columns 23 with voltages Gⱼ(t) having (p+1) voltage levels.

This is shown in FIG. 5 for a drive of four rows at a time. Four orthogonal selection signals F₁(t), F₂(t), F₃(t), F₄(t) are presented to the rows during tₛₑ₁. To obtain the information shown (pixel at row 1 and column 1 off, all others on), a signal

$${G}_{1} ( t ) = \frac{C}{\sqrt{4}} ( {F}_{1} ( t ) - {F}_{2} ( t ) - {F}_{3} ( t ) - {F}_{4} ( t ) )$$

is necessary at column 1, and a signal

$${G}_{2} ( t ) = \frac{C}{\sqrt{4}} ( - {F}_{1} ( t ) - {F}_{2} ( t ) - {F}_{3} ( t ) - {F}_{4} ( t ) )$$

is necessary at column 2.

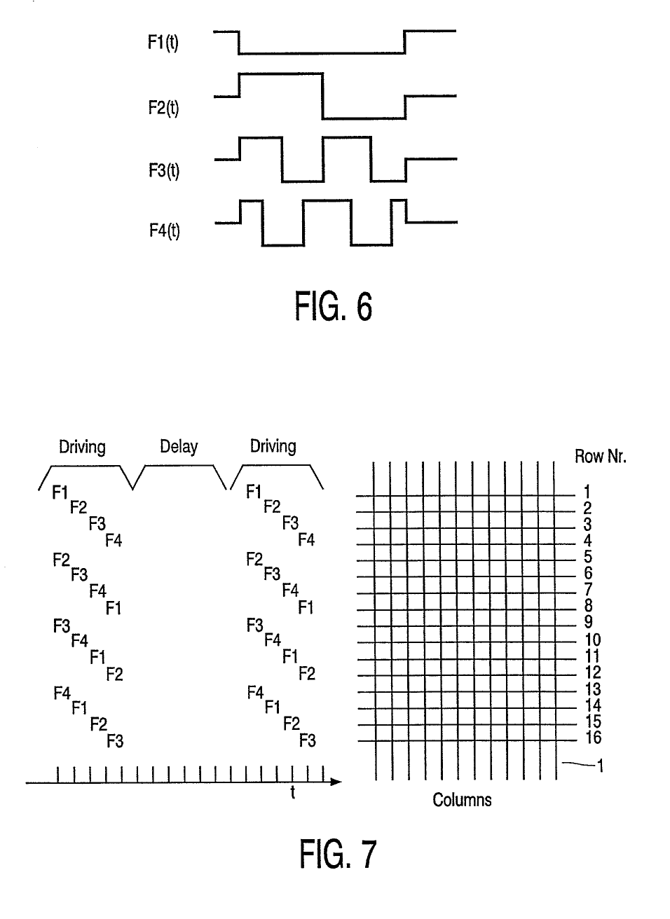

The mutual orthogonality of the functions F₁(t), F₂(t), F₃(t), f₄(t) is shown in FIG. 6.

As already stated, the simultaneous presentation of the functions F₁(t), F₂(t), F₃(t), F₄(t) to four juxtaposed rows leads to irregularities in the picture. To prevent this, the set of orthogonal selection signals F₁(t), F₂(t), F₃(t), F₄(t) is first presented (tₛₑ₁1) to the rows 1, 5, 9, 13 in the embodiment of FIG. 7. In a subsequent addressing period, the orthogonal selection signals F₁(t), F₂(t), F₃(t), F₄(t) are presented to the rows 2, 6, 10, 14, etc. To prevent loss of contrast, the selection signals F₁(t), F₂(t), F₃(t), F₄(t) are spread across the sub-frames (here the groups of rows 1-4, 5-8, 9-12, etc.) in a uniform way. In FIG. 7, the selection signals are repeated in a subsequent drive period (tₛₑ₁2); mutual exchange of the signals F₁(t), F₂(t), F₃(t), F₄(t) is also possible in later drive periods.

The invention is of course not limited to the embodiment shown, but several variations are possible. For example, it is not absolutely necessary to make use of the reflective properties of cholesteric-nematic liquid crystal material. With a suitable choice of thickness and material, polarization rotation occurs in cholesteric nematic liquid crystal material. Transmissive display devices can then be realized by means of polarizers and a suitable detection means. The orthogonal signals may be generated in various ways.

As stated in the opening paragraph, it is possible to reduce switching times between the different states by means of a special drive mode with the aid of a preparation phase and an evolution phase, in which the actual selection period is between these phases. Also the separate use of a preparation phase or an evolution phase is possible. In this case, a display device based on the cholesteric nematic liquid crystal effect driven in this way is driven with orthogonal signals again during the selection period.

The invention resides in each and every novel characteristic feature and each and every combination of characteristic features.

1. A display device comprising a first substrate provided with row electrodes and a second substrate provided with column electrodes, in which overlapping parts of row and column electrodes with an interpositioned layer of electro-optical material define pixels, said electro-optical layer comprising a nematic liquid crystal material which is capable of assuming a plurality of states, further comprising drive means for driving the row electrodes with selection signals and for driving the column electrodes with data signals in conformity with an image to be displayed, characterized in that the drive means comprise means for bringing, in the operative state and prior to a selection period, the liquid crystal material in groups of p rows of pixels in a defined state, said drive means sequentially applying mutually orthogonal signals to m groups of p row electrodes (p>1) in the operative state during a selection period and selecting the rows i, i+p, i+2p, . . . i+(m−1)p during a selection period, (i=1, 2, . . . p).

2. A display device as claimed in claim 1, characterized in that mutually orthogonal signals are applied to each group of p consecutive row electrodes of the display device.

3. A display device as claimed in claim 1, characterized in that the electro-optical layer comprises a chiral nematic liquid crystal material which is capable of assuming a plurality of states, at least a focal-conic state and a planar state of which are stable in the absence of an electric field.

4. A display device as claimed in claim 3, characterized in that, in the operative state and prior to a selection period, the drive means bring the liquid crystal material in groups of p rows of pixels to a homeotropic state.

5. A display device as claimed in claim 3, characterized in that mutually orthogonal signals, based on Walsh functions, are sequentially applied to the groups of row electrodes.

6. A display device as claimed in claim 3, characterized in that the drive means comprise means for applying, prior to selection, preparation signals to pixels to be selected.

7. A display device as claimed in claim 3, characterized in that the drive means comprise means for applying, after selection, evolution signals to pixels.

8. A display device as claimed in claim 3, characterized in that the optical rotation of the layer of electro-optical material in the focal-conic state and in the planar state has different values, and in that the display device comprises means allowing discrimination between these different values.
